(19) United States
(12) Patent Application Publication
(10) Pub. No.: US 2005/0090145 A1
(43) Pub. Date: Apr. 28, 2005

(54) Cable coupler device for electric facilities

(76) Inventor: Hua Kanq Wu, Chong Ho City (TW)

Correspondence Address: Hua Kang Wu, P.O.Box 10-69, Chong Ho, Taipei, 235, TW

(21) Appl. No.: 10/694,573

(22) Filed: Oct. 23, 2003

(51) Int. Cl. H01R 13/60

(52) U.S. Cl. 439/535

(57) ABSTRACT

A cable coupler device includes a receptacle two or more sides each having one or more orifices or apertures or openings, and a circuit board received in the receptacle and having two or more couplers engaged in the orifices or apertures or openings of the receptacle, for allowing the couplers to be directed toward different directions relative to each other, and thus for allowing the receptacle to be attached to corner areas of house buildings. The sides of the receptacle are preferably perpendicular to each other. The couplers may be IEEE couplers or USB couplers, or other couplers.

### BACKGROUND OF THE INVENTION

1. Field of the Invention

The present invention relates to a cable coupler device, and more particularly to a cable coupler device for coupling cables of electric facilities or computer facilities or the like.

2. Description of the Prior Art

Typical cable couplers have been developed for coupling electric wires or cables of telephone systems or telecommunicating systems, for example, for allowing the telephone systems or the telecommunicating systems to be easily installed in house buildings.

For the other electric facilities or computer facilities or other telecommunicating facilities, a number of particular electric wires or cables, such as institute of electrical and electronic engineers (IEEE) cables, universal serial bus (USB) cables, or the like are required to be coupled between parts or elements or circuits.

However, the IEEE cables or the USB cables or the like may not be easily cut and then coupled together, and thus may not be easily used to couple various parts or elements or circuits in house buildings.

In addition, in almost all of the house buildings, a number of corners will be formed between walls and/or floor. However, normally, the typical cable couplers include two opposite plugs or sockets for coupling to cables respectively, such that the typical cable couplers may not be attached to the corner areas of the house buildings to couple the cables together at opposite sides of the cable couplers.

The present invention has arisen to mitigate and/or obviate the afore-described disadvantages of the conventional cable couplers.

### SUMMARY OF THE INVENTION

The primary objective of the present invention is to provide a cable coupler device for coupling cables of electric facilities or computer facilities or the like, and particularly for being attached to corner areas of house buildings.

In accordance with one aspect of the invention, there is provided a cable coupler device comprising a receptacle including a first side having at least one orifice formed therein, and a second side having at least one aperture formed therein, and a circuit board received in the receptacle, and including at least one first coupler attached thereto and engaged in the orifice of the receptacle, and including at least one second coupler attached thereto and engaged in the aperture of the receptacle, for allowing the first coupler and the second coupler to be directed toward different directions relative to each other.

The first side and the second side of the receptacle are perpendicular to each other. The first coupler and the second coupler are IEEE couplers, or are USB couplers.

The receptacle includes an upper portion having at least one opening formed therein, and the circuit board includes at least one third coupler attached thereto and engaged in the opening of the receptacle. The third coupler is an IEEE coupler or a USB coupler.

The receptacle includes a second orifice formed therein, and the circuit board includes at least one third coupler attached thereto and engaged in the second orifice of the receptacle, for coupling to power source.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a cable coupler device in accordance with the present invention;

FIG. 2 is a partial exploded view of the cable coupler device;

FIG. 3 is a perspective view illustrating the operation of the cable coupler device;

FIG. 4 is a perspective view illustrating the cable coupler device having different couplers;

FIG. 5 is a partial exploded view of the cable coupler device as shown in FIG. 4; and

FIG. 6 is a perspective view illustrating the operation of the cable coupler device as shown in FIGS. 4 and 5.

### DETAILED DESCRIPTION OF THE PREFERRED EMBODIMENT

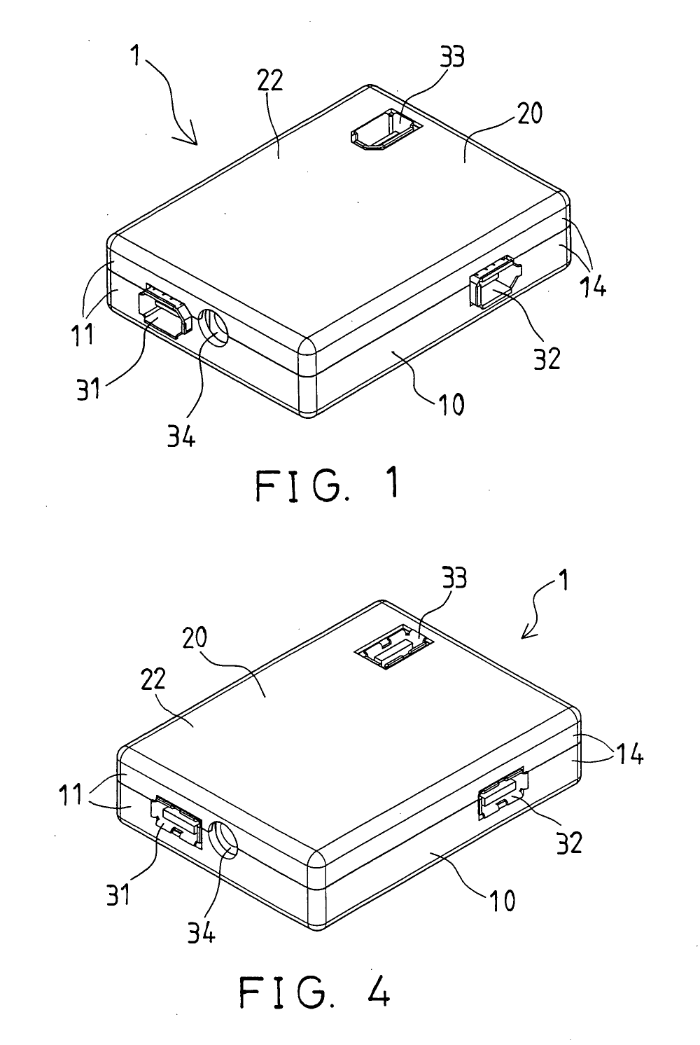

Referring to the drawings, and initially to FIGS. 1-3, a cable coupler device in accordance with the present invention comprises a receptacle 1 including a lower housing 10 and an upper housing 20 to be secured together with fasteners, latches (not shown), adhesive materials, or by welding processes.

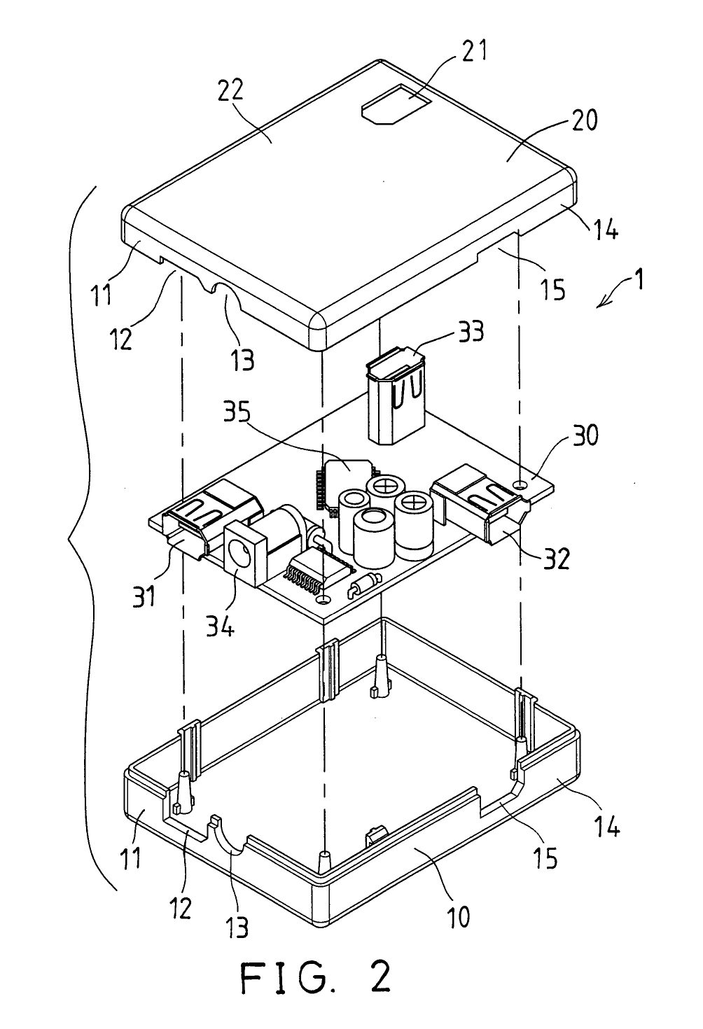

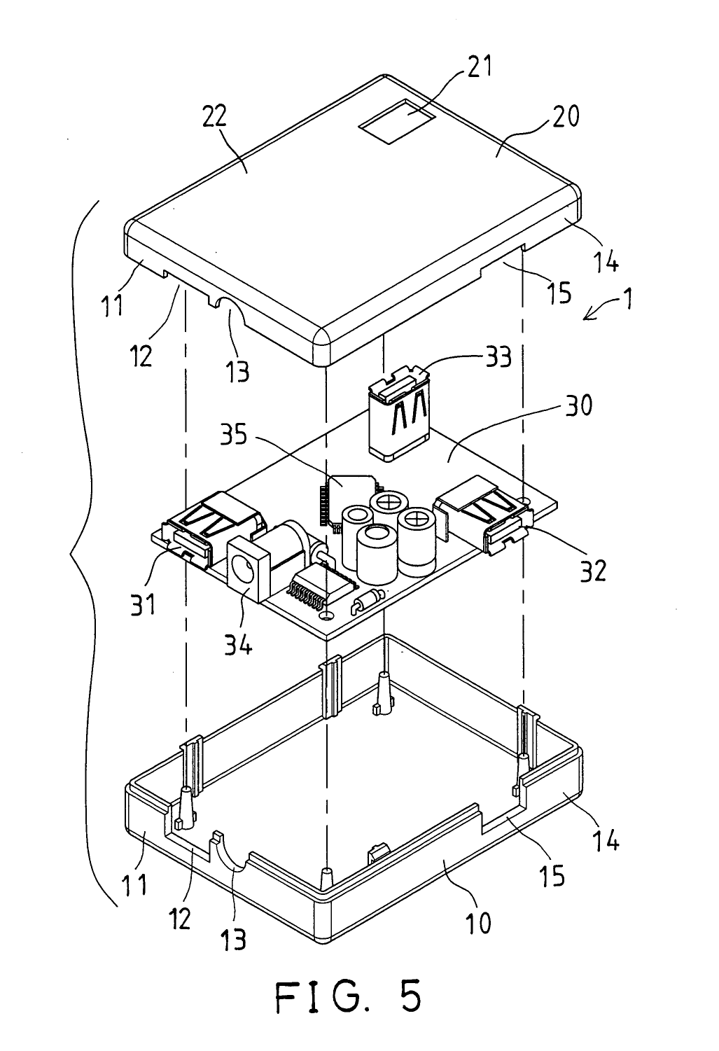

Each of the housings 10, 20 of the receptacle 1 includes one side 11 having one or more orifices 12, 13 formed therein, and another side 14 having one or more apertures 15 formed therein. The orifices 12, 13 and the apertures 15 of the housings 10, 20 are aligned or mated with each other. The upper housing 20 includes one or more openings 21 formed in the upper surface or portion 22 thereof (FIGS. 2, 5).

A circuit board 30 is received and retained between the housings 10, 20 of the receptacle 1, and include three or more couplers 31, 32, 33 attached thereto and directed toward different directions, for engaging into the orifices 12 and the apertures 15 and the openings 21 of the housings 10, 20 of the receptacle 1 respectively.

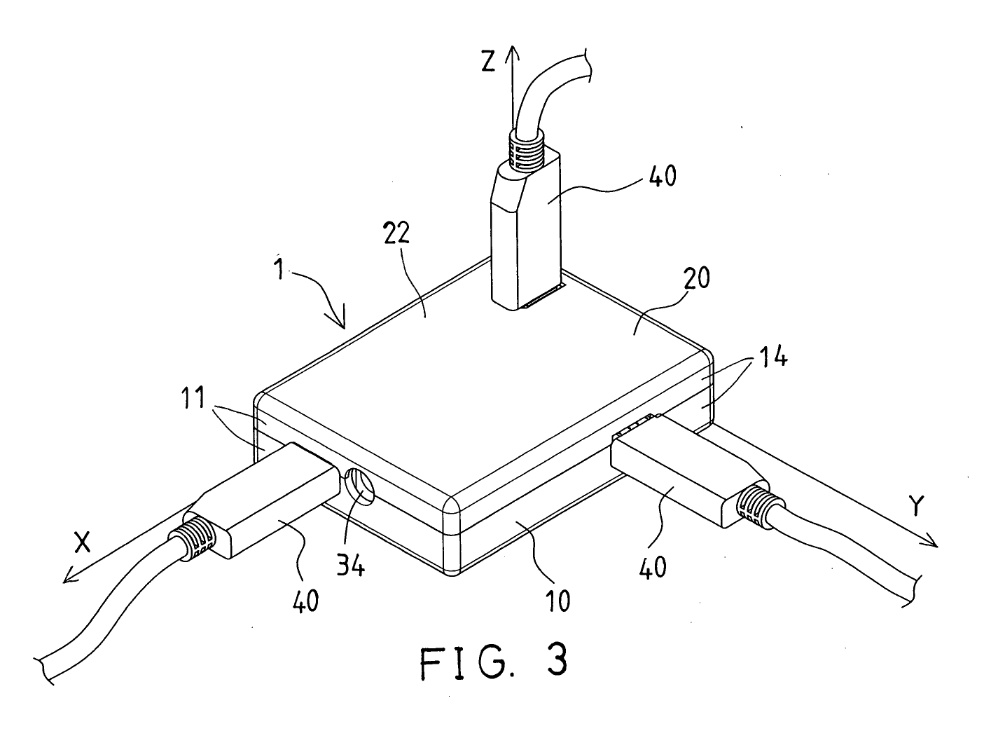

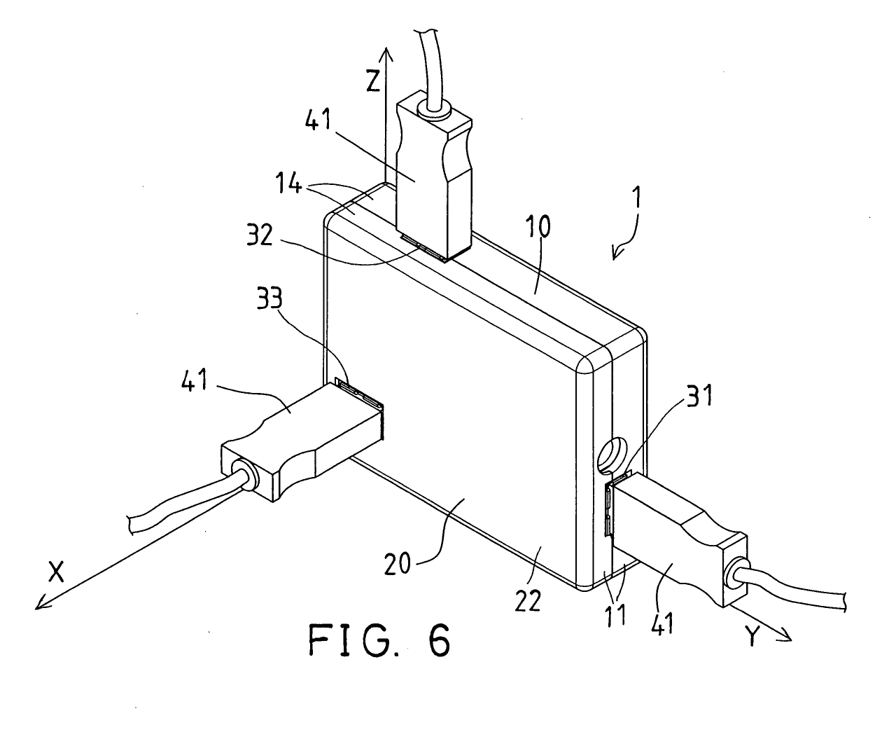

For example, as shown in FIGS. 1, 3 and 4, 6, the couplers 31, 32, 33 are attached to the circuit board 30 and directed toward different directions, such as X, Y, and Z directions (FIGS. 3, 6), relative to each other, for allowing the cable coupler device to be attached to corner areas of house buildings.

As shown in FIGS. 3 and 6, the sides 11, 14 of the housings 10, 20 of the receptacle 1 are perpendicular to each other, and are perpendicular to the upper surface or portion 22 of the upper housing 20 of the receptacle 1, for allowing the sides 11, 14 and the upper surface or portion 22 of the housings 10, 20 of the receptacle 1 to be exposed when the cable coupler device is attached to corner areas of house buildings, and for allowing the couplers 31, 32, 33 to be attached to the circuit board 30 and directed toward different directions.

In operation, as shown in FIGS. 3 and 6, three or more plugs or couplers 40, 41 may be coupled or plugged to the couplers 31, 32, 33 of the receptacle 1 of the cable coupler device from different directions of the receptacle 1, to allow the cable coupler device to be attached and installed to the corner areas of the house buildings.

As shown in FIGS. 2 and 5, the circuit board 30 includes another coupler 34 engaged in the orifice 13 of the housings 10, 20 of the receptacle 1, for coupling to electric power suppliers, for example, and includes one or more electric elements, such as integrated circuits 35 thereon, for data or information processing purposes.

As shown in FIG. 2, the couplers 31, 32, 33 of the circuit board 30 may be provided or designed for IEEE specifications or types or the like, such as for IEEE 1394, and are provided for coupling to IEEE cables or couplers 40 (FIG. 3).

Alternatively, as shown in FIG. 5, the couplers 31, 32, 33 of the circuit board 30 may be provided or designed for USB types or specifications or the like, and are provided for coupling to USB cables or couplers 41 (FIG. 6).

Accordingly, the cable coupler device in accordance with the present invention may be attached to corner areas of house buildings, for easily coupling cables of electric facilities or computer facilities or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A cable coupler device comprising:
a receptacle including a first side having at least one orifice formed therein, and a second side having at least one aperture formed therein, said first side and said second side of said receptacle being perpendicular to each other, said receptacle including an upper portion having at least one opening formed therein, and
a circuit board received in said receptacle, and including at least one first coupler attached thereto and engaged in said at least one orifice of said receptacle and directed toward X-direction, and including at least one second coupler attached thereto and engaged in said at least one aperture of said receptacle and directed toward Y-direction, and said circuit board including at least one third coupler attached thereto and engaged in said at least one opening of said receptacle and directed toward Z-direction, for allowing said at least one first coupler and said at least one second coupler and said at least one third coupler to be directed toward different directions relative to each other.

2 (canceled).

3. The cable coupler device as claimed in claim 1, wherein said at least one first coupler and said at least one second coupler are IEEE couplers.

4. The cable coupler device as claimed in claim 1, wherein said at least one first coupler and said at least one second coupler are USB couplers.

5 (canceled).

6. The cable coupler device as claimed in claim 1, wherein said at least one third coupler is an IEEE coupler.

7. The cable coupler device as claimed in claim 1, wherein said at least one third coupler is a USB coupler.

8. The cable coupler device as claimed in claim 1, wherein said receptacle includes a second orifice formed therein, and said circuit board includes at least one fourth coupler attached thereto and engaged in said second orifice of said receptacle, for coupling to power source.
